(19) United States
(12) Patent Application Publication
(10) Pub. No.: US 2009/0245019 A1
(43) Pub. Date: Oct. 1, 2009

(54) Method and system for determining geodetic positions of towed marine sensor array components

(76) Inventors: Jon Falkenberg, Jar (NO); Sverre Olsen, Lommendalen (NO)

Correspondence Address: E. Eugene Thigpen;Petroleum Geo-Services, Inc., P.O. Box 42805, Houston, TX, 77242-2805, US

(21) Appl. No.: 12/080,198

(22) Filed: Mar. 31, 2008

(51) Int. Cl. G01V 1/38

(52) U.S. Cl. 367/17; 367/19

(57) ABSTRACT

A method for determining positions of geophysical sensor streamers includes towing laterally spaced apart streamers maintained in relative relationship therebetween by paravanes proximate their forward ends. The streamers include spaced apart acoustic transmitters and acoustic receivers. The paravanes each include an acoustic transmitter or receiver. Signals are sent from the acoustic transmitters and are received at the acoustic receivers. Geodetic position signals are detected at each paravane. The identities of the transmitters of the received acoustic signals are determined to determine travel times of the received acoustic signals. The travel times are converted to distances between the identified transmitters and the receivers. Relative positions of the streamers are determined from the distances. The relative positions of the streamers are combined with the detected geodetic position signals to determine geodetic positions of the streamers.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates generally to the field of geophysical prospecting. More particularly, the invention relates to the field of marine geophysical data acquisition.

2. Background Art

To perform a three-dimensional (3D) marine geophysical survey such as a seismic survey, a plurality of marine seismic streamers are towed at a preset depth, typically between 4 and 25 meters, behind a surface survey vessel. Each seismic streamer, also referred to as a streamer cable, is typically several thousand meters long and contains a series of seismic sensors and associated analog-to-digital signal converter electronics distributed along the streamer length. The streamer cables comprise a series of individual segments, called streamer sections, each typically 75 to 200 meters long. The survey vessel also tows one or more seismic sources, for example air guns or water guns, but most commonly consisting of arrays of air guns. Acoustic signals generated by the seismic sources are transmitted down through the water column and several more kilometers down into the subterranean formations. Parts of the signals are reflected from the interfaces between various strata, due to differences in the acoustic impedance between different rock formations. The acoustic signals reflected from the subterranean formations are detected by the seismic sensors located within the streamers. The acquired seismic signals are digitized and sent via a main telemetry link to the survey vessel for data processing onboard or later processing onshore. The processed data is used for estimating the subterranean formation structure and possible hydrocarbon content.

FIG. 1A illustrates a top schematic view of an ideal case, with no cross-currents, of a 3D marine seismic survey using towed streamers. A seismic survey vessel 1 tows a relatively small seismic tow system which comprises an active source consisting of three air gun arrays 2, and a spread of four streamer cables 3. The streamer cables 3 extend from paravanes 4 at the front of the spread to tail buoys 5 at the rear. In this ideal case, the streamer cables 3 all extend behind the vessel 1 in unrealistically straight and equally spaced lines parallel to the vessel track and to each other. FIG. 1B illustrates a top schematic view of a more realistic case of a 3D marine seismic survey using towed streamers, showing the typical effects of cross-currents on the streamer spread. The separations between the streamers 3 are no longer constant and the positions of the tail segments deviate from the vessel track. This deviation effect is called “feathering”. The tail segments of the streamers can, in some survey areas, deviate significantly from the vessel track due to the cross-currents along the tow spread.

For correct seismic imaging of the sub-bottom beneath the survey area, it is important to accurately determine the position of both the air gun sources and the seismic receivers. The seismic sources are towed relatively closely behind the survey vessel and are easier to control than the streamer spread. Streamer spreads typically consist of 8 to 12 independently towed streamer cables, with each streamer being 3 to 8 kilometers long. However, the trend is to deploy even more and longer streamers, such as up to 20 streamers of approximately 12 kilometers length. Accurate determination of streamer positions is also important in avoiding high risk operational situations such as streamer tangling. The tangling can be caused by strong water currents in the sea when more than one cable is hooked up and connected. Resolving such tangling scenarios is complex and may expose the seismic crew to hazardous in-sea operations, in addition to being quite costly.

U.S. Patent Application Publication No. 2007/0091719 filed by Falkenberg et al., the underlying patent application for which is assigned to the assignee of the present invention, describes a system for determining relative positions of geophysical sensor streamers using acoustic devices to determine relative distances between the streamers in an in line and in a cross line direction. Methods for determining streamer geodetic positions known in the art include the use of devices such as global positioning system (“GPS”) satellite signal receivers and magnetic compasses (also referred to as magnetic heading sensors or “compass birds”). Typically, a geodetic position is determined at a selected position in the acquisition system, such as onboard the survey vessel. Another selected position may be on a float used to suspend a seismic air gun array in the water. The geomagnetic heading of the streamers measured by the compass birds is combined with the geodetic position measurements and the relative position measurements to obtain an estimate of the geodetic position of all the sensors in the streamers. The foregoing techniques may be relatively inaccurate because of error in determining geomagnetic declination, the difficulty of measuring relative distances between the survey vessel and the streamers and because of uncontrolled position displacement between the measured geodetic position of the air gum float and the position of an acoustic transducer used for relative distance determination. As will be appreciated by those skilled in the art, seismic air guns are typically suspended from the float by chains or cables, and thus can move relative to the position of the float in an uncontrolled manner.

All of the foregoing explanation also applies to marine geophysical sensing systems in which sensors other than seismic sensors are disposed in laterally spaced apart towed streamers, for example, electrodes for electromagnetic surveying, temperature sensors, magnetometers, etc.

Thus, a need exists for an improved method for determining geodetic positions of towed marine geophysical streamers during survey operations.

### SUMMARY OF THE INVENTION

A system for determining geodetic positions of a plurality of laterally spaced marine geophysical sensor streamers according to one aspect of the invention includes a plurality of sensor streamers each functionally coupled at a forward end thereof to a towing vessel. A paravane is disposed laterally outwardly on each side of the plurality of streamers, and each paravane is configured to maintain lateral separation of the streamers. A plurality of acoustic transmitters are disposed at spaced apart locations along the streamers. The transmitters are configured to transmit signals enabling identification of each of the transmitters from which the signals originate. A plurality of acoustic receivers is disposed at spaced apart locations along the streamers. The receivers are configured to receive the signals from the transmitters. A geodetic position signal receiver, and at least one of the acoustic transmitters and the acoustic receivers are disposed on each paravane. At least one processor is configured to determine identities of transmitters of received acoustic signals and travel times of the received acoustic signals. The processor is further configured to convert the travel times to distances in both an in-line direction along streamers between transmitters and acoustic receivers in the same streamer, and in a cross line direction between transmitters and acoustic receivers in different streamers. The processor is also configured to determine relative positions of the streamers from the distances. The processor is configured to determine geodetic positions of the streamers from the relative positions and the signals detected by the geodetic position signal receiver on each paravane.

A method for determining positions of towed marine geophysical sensor streamers according to another aspect of the invention includes towing a plurality of laterally spaced apart streamers. The streamers are maintained in relative lateral relationship therebetween by paravanes proximate a forward end of the streamers. The streamers include acoustic transmitters disposed at spaced apart locations. The transmitters are configured to transmit signals enabling identification of the one of the transmitters from which the signals are transmitted. The streamers include a plurality of acoustic receivers disposed at spaced apart locations therealong. The acoustic receivers are configured to receive the signals from the transmitters. The paravanes each include at least one acoustic transmitter or one acoustic receiver. Signals are sent from the acoustic transmitters and are received at the acoustic receivers. Geodetic position signals are detected at each paravane. The identities of the transmitters of the received acoustic signals are determined to determine travel times of the received acoustic signals. The travel times are converted to distances between the identified transmitters and the receivers. Relative positions of the streamers are determined from the distances. The relative positions of the streamers are combined with the detected geodetic position signals to determine geodetic positions of the streamers.

Other aspects and advantages of the invention will be apparent from the following description and the appended claims.

### BRIEF DESCRIPTION OF THE DRAWINGS

FIG. 1A is a top schematic view of an ideal case, with no cross-currents, of a 3D marine geophysical survey using towed streamers.

FIG. 1B is a top schematic view of a more realistic case, with cross-currents, of a 3D marine geophysical survey using towed streamers.

FIG. 1C is a more detailed plan view of a marine seismic acquisition such as shown in FIGS. 1A and 1B.

FIG. 2 is a top schematic view of a system for determining positions of towed marine geophysical streamers, according to an example of the invention.

FIG. 2A shows an example paravane according to one aspect of the invention.

FIG. 3 is a perspective schematic view of a portion of a streamer section with seismic acquisition receivers, according to an example of the invention.

FIG. 4 is a perspective schematic view of a streamer section with streamer position-determining transmitters and receivers, according to an example of the invention.

FIG. 5A is a flowchart illustrating the processing steps of a main processor for an example of the method of the invention for determining the relative positions of towed marine geophysical streamers.

FIG. 5B is a flowchart illustrating the processing steps of a selected receiver processor for an example of the method of the invention for determining travel times of received signals transmitted by transmitters to the position-determining receivers under the control of the selected receiver processor.

FIG. 5C is a flowchart illustrating the processing steps of a receiver processor for an example of the method of the invention for determining a properly-compensating Doppler shift, source transmitter identity, and travel time for a received signal at a position-determining receiver under the control of the receiver processor.

FIG. 5D is a flowchart illustrating the processing steps of a receiver processor for an example of the method of the invention for calculating a selected Doppler shift and a resulting travel time for a selected received signal from a selected transmitter to a position-determining receiver under the control of the receiver processor.

FIG. 6A is a side schematic view of a broad band transmitter, as mounted in a streamer, according to one example of the invention.

FIG. 6B is a side sectional view of the transmitter of FIG. 6A.

FIG. 6C is a side perspective view of the protective tube used in the transmitter of FIG. 6B.

FIG. 7A is a side sectional view of a broad band receiver, according to an example of the invention.

FIG. 7B is a cross-sectional view of the receiver of FIG. 7A.

FIG. 7C is a side schematic view of the receiver of FIGS. 7A and 7B, as mounted in a streamer.

### DETAILED DESCRIPTION

The invention is a system and method for determining the geodetic positions of data acquisition equipment, in particular the sensors used in multiple streamer cables in a towed marine geophysical acquisition system. One example of such a system is a seismic survey system for imaging subterranean formations.

The acquisition system generally comprises a plurality of sensor streamers towed by a survey vessel. The streamers are laterally spaced apart from each other. In one example, acoustic transmitters and acoustic are receivers distributed along the length of the streamers. The acoustic transmitters and receivers in the streamers may include corresponding power and control electronics in each of the streamers.

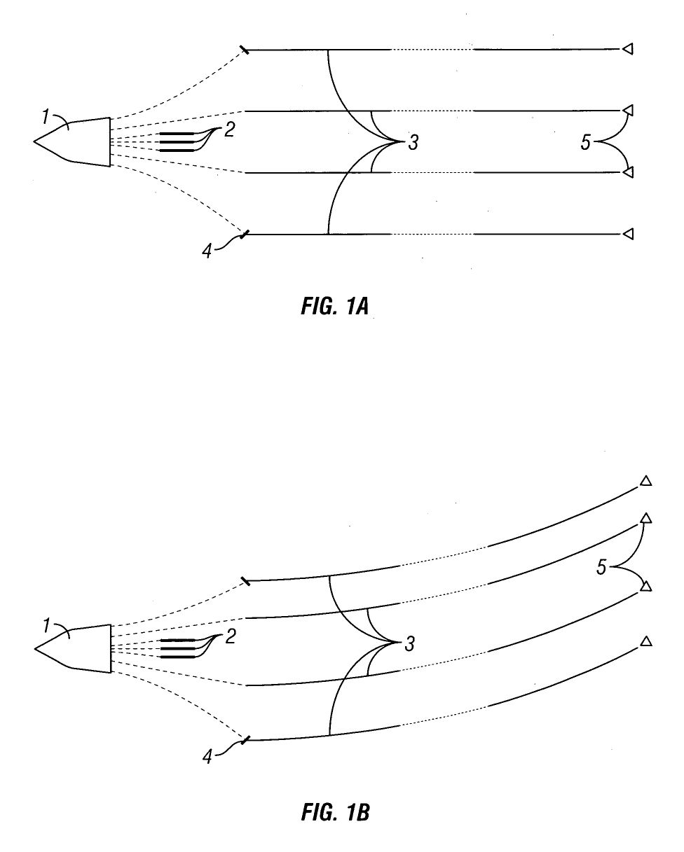

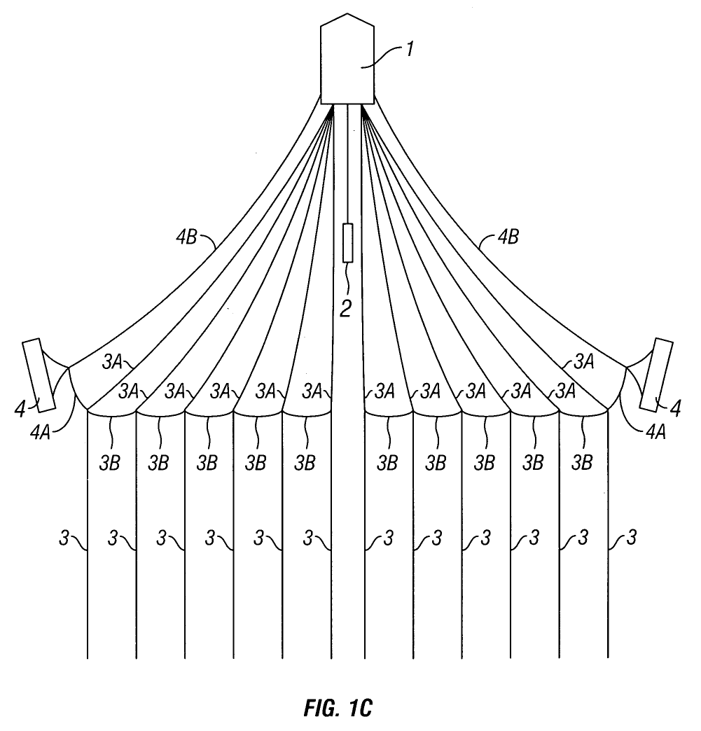

At least one acoustic transmitter or receiver is disposed on each of two paravanes. As explained above with reference to FIG. 1A, the paravanes are used to maintain the lateral spread of the towing equipment that couples the streamers to the survey vessel. The acoustic transmitter or receiver on each paravane is used for determining the streamer positions with respect to the paravanes. Geodetic position of the paravanes is determined by detecting geodetic position signals at each of the paravanes. Each paravane therefore includes a geodetic position signal receiver. The geodetic positions determined from the geodetic position signals, and the relative positions determined from acoustic travel time measurements are then combined to determine geodetic positions at any point along each of the streamers.

In one example, the geodetic position signal receiver on each paravane, and the associated acoustic transmitter and/or receiver may be locally powered by an electric generator configured to be operated by movement of the paravane through the water. Ordinarily, paravane tow ropes that do not use electrical conductors are used to couple the paravanes to the system towing equipment. In other examples where a local generator on each paravane is not used, instrumentation on the paravanes may be operated by an electrical cable extending to each paravane from the laterally closest streamer.

In some examples, acoustic signals from the transmitters located within a section of a streamer cable may be detected by a plurality of dedicated receivers located within other sections of a streamer cable. The acoustic receivers can be located both within the same streamer as the transmitter for inline ranging and within other streamers for volumetric determination. Processing the acquired signals yields the propagation times between combinations of transmitters and receivers and hence the distances between these transmitter and receiver combinations. These distances can then be used, in turn, to calculate the relative positions of the transmitters and receivers in the streamers. Similar devices and methods may be used to determine relative positions of the paravanes with respect to the streamers.

A more detailed view of a typical marine seismic acquisition system is shown in FIG. 1C, wherein the survey vessel 1 tows a plurality of laterally spaced apart streamer cables 3. The streamer cables 3 are coupled at their respective forward ends to the vessel 1 by a corresponding lead in cable 3A. The lateral separation between the streamers 3 is maintained by spreader ropes 3B disposed between the forward ends of adjacent streamers 3 on each side of the centerline of the acquisition system. The lateral force generated by each of the paravanes 4 is conducted to the corresponding laterally outermost streamer 3 using a respective spur line 4A. The paravanes 4 are coupled to the vessel 1 using paravane tow ropes, also referred to as “superwide” ropes, shown at 4B in FIG. 1C. Only one source 2 is shown in FIG. 1C for clarity of the illustration.

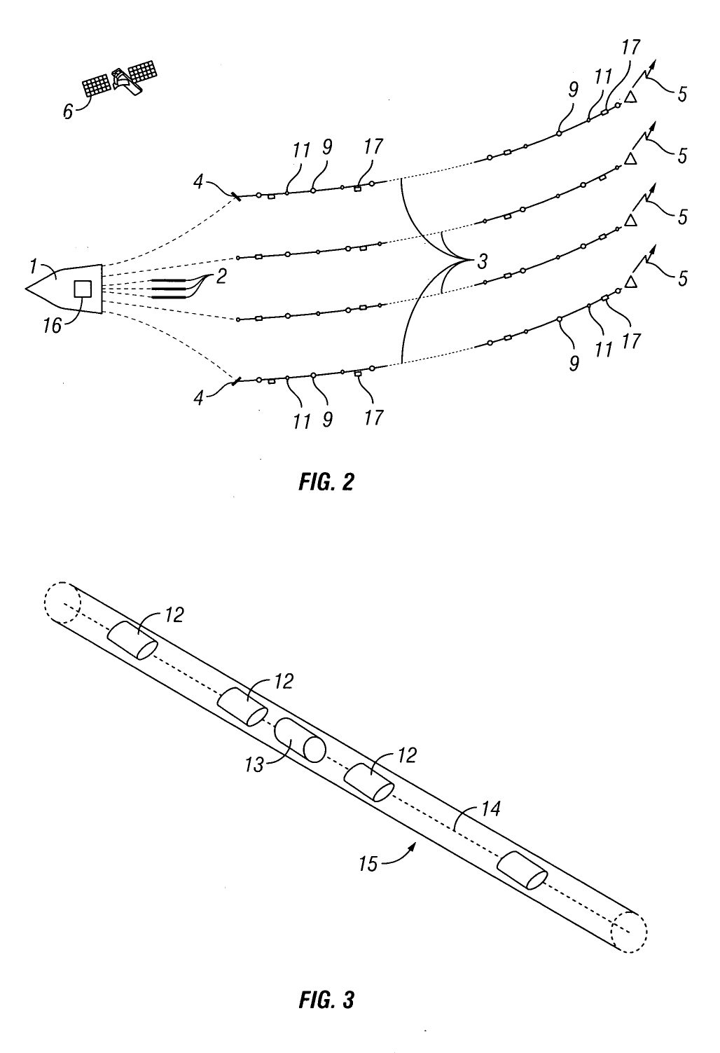

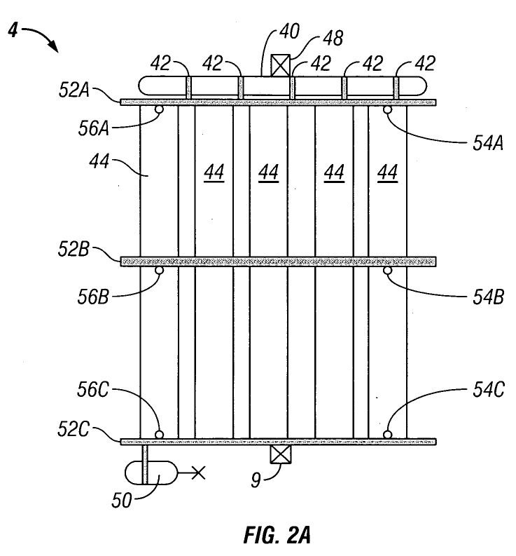

Having explained the system in general terms, a specific example will now be explained. FIG. 2 illustrates an overhead schematic view of an example system for determining positions of towed marine seismic streamers. A geophysical survey vessel 1 tows a geophysical sensor system. In the present example, the system includes a geophysical energy source, for example, three seismic air gun arrays 2, and a spread of four sensor streamer cables (or simply, “streamers”) 3. The sensor streamer cables 3 extend from streamer separation deflectors 4 proximate the front of the system to tail buoys 5 at the aft end of each streamer. Geodetic position signal receivers, for example, global positioning system (“GPS”), Glonass, Gallileo or any other geodetic signal receiver (shown schematically in FIG. 2A) may be located on the vessel 1, on the air gun arrays 2 and on tail buoys 5, and receive signals from, for example, navigation satellites 6 in Earth orbit and provide accurate geodetic positions at the locations of such receivers.

In the present example, the paravanes 4 each also includes a geodetic position signal receiver. As will be explained below with reference to FIG. 2A, in some examples, the geodetic position information detected by the GPS receivers may be used with a substantially collocated, submerged acoustic transmitter (or receiver) in each paravane 4 to assist in determining the geodetic positions along each streamer 3. The streamers 3 include a plurality of geophysical sensors (not shown) such as seismic sensors, electrodes and/or magnetometers for sensing various geophysical parameters that are the subject of the survey conducted by the acquisition system.

The streamer position-determining system can also include a number of acoustic transmitters 9 and acoustic receivers 11 mounted inside sections (not shown in FIG. 2) of the streamers 3. The transmitters 9 and receivers 11 communicate with a main processor 16 via an electrical bundle (shown in FIG. 3 as 14) within the streamers 3. The main processor 16 is typically located onboard the survey vessel 1, although this location should not be considered a limitation of the invention. A transmitter 9 and a receiver 11 may be combined in one transceiver unit, although this combination should not be considered a limitation of the invention. If the transmitter 9 and receiver 11 are combined into one transceiver unit, then this transceiver unit can act as either a transmitter 9 or a receiver 11 or even both (although not simultaneously).

In one example, the acoustic system for determining relative streamer positions transmits signals within the frequency range of 10 kHz to 40 kHz. This frequency band is selected to avoid signal degradation in hostile acoustic environments that occurs when higher ultrasonic frequencies are utilized and the decreased signal resolution that occurs when lower frequencies are utilized. The transmitters 9 transmit an acoustic signal in the water and the receivers 11 receive these transmitted signals. Several transmitters 9 may transmit at the same time, but different transmitters 9 transmit different signals. The different signals from different transmitters have low cross-correlation, so that a receiver 11 can distinguish between different transmitter signals even if the signals arrive simultaneously.

One method for generating a signal with a wide bandwidth and with the flexibility to generate a number of different transmitter waveforms with low cross-correlation is to use pseudo random noise codes. Two examples of pseudo random noise sequences that are appropriate for the invention are the Gold sequence and the Kasami sequence. Direct sequence spread spectrum techniques can be used to modulate a single carrier frequency with these pseudo random noise sequences to generate a spread signal. Two different modulation techniques can be applied. In the first technique, the pseudo random noise sequence directly modulates the carrier frequency and accomplishes the full band spread. In the second technique, linearly swept chirps represent the states of the pseudo random noise sequence and the band spread lies mainly in the chirps. This second modulation technique can use smaller pseudo random noise sequences to generate different transmitter waveforms with reasonably small cross-correlations. Such an approach may yield better correlation results than using modulation functions with zero cross-correlation.

The transmitters 9 and receivers 11 are time synchronized from the main processor 16, which transmits a time synchronization signal received by all the transmitters 9 and receivers 11. Each transmitter 9 transmits a unique acoustic signal, according to a pre-set triggering schedule of transmissions for that transmitter 9. At least one receiver 11 detects the transmitted signal during a pre-set schedule of listening time windows for that receiver 11. The propagation time between the transmitter 9 and the receiver 11 is estimated based on the time difference between the known triggering time of the transmitter 9 and the calculated arrival time at the receiver 11 of the transmitted signal from the transmitter 9. The range between transmitter 9 and the receiver 11 can then be calculated, based on knowledge of the sound velocity in the water. The receiver 11 can listen for acoustic signals from several transmitters 9 at the same time and hence determine the range to several transmitters 9 in the system simultaneously.

In one example, the speed of sound in the water is measured by sound velocity sensors 17 located along the streamers 3. Sound velocity sensors 17, well known in the art, typically measure the speed of sound in water directly, typically by an acoustic time of flight measurement, or calculate the speed of sound in water indirectly from other sensor-measured parameters, typically conductivity (to determine salinity), temperature, and depth (to determine pressure). In other embodiments, however, the velocity sensors 17 can be located elsewhere, such as, for example, in separate modules inserted between the streamer sections 15, in towing apparatus at the front of the streamers 3, in steering apparatus along the streamers 3, or in tail buoys at the rear of the streamers 3. Moreover, the use of velocity sensors 17 is not meant to be a limitation of the invention, as the speed of sound in the water may be determined by other means known in the art.

The system as presented in FIG. 2 can be used for inline ranging along the length of a streamer 3, which, for example, can provide a measurement of the amount of stretch in a streamer 3 due to the tension of being towed. The acoustic signal from a transmitter 9 is detected by one or more receivers 11 located within the same streamer 3. The distance between a transmitter 9 and a receiver 11 is computed using the estimated propagation time of the signal and the speed of sound in the water. As before, the speed of sound in the water may be measured using velocity sensors 17 located along the streamers 3 or by any other means known in the art.

FIG. 2A shows a cross section of one example of a paravane having both a geodetic position receiver and either one of an acoustic transmitter or receiver as explained above. The paravane 4 includes several principal components, including a generally longitudinally extending float or buoy 40 that maintains the paravane 4 in a selected position with respect to the water surface and buoyantly supports the remainder of the components of the paravane 4. The float 40 can be coupled, for example, by clamps, brackets or bands 42 to an upper deflector frame 52A. The upper deflector frame 52A can provide mounting and support for the uppermost ends of a plurality of substantially vertically extending diverters or deflectors 44, each of which has a selected shape and orientation with respect to the longitudinal axis of the paravane 4 to redirect movement of water as the paravane 14 is towed by the vessel (1 in FIG. 2). Such redirection of the water movement results in lateral force (i.e., transverse to the direction of motion of the vessel) being generated by the paravane 4. In the present example, the deflectors 44 are supported approximately in their longitudinal center by a center deflector frame 52B, and at their lower longitudinal ends by a lower deflector frame 52C. Collectively, the deflector frames 52A, 52B, 52C maintain the position of and the orientation of the deflectors 44 with respect to the float 40. The deflectors 44 can be rigidly mounted in the frames 52A, 52B, 52C.

Each deflector frame 52A, 52B, 52C may include respective forward bridle cable couplings, such couplings shown at 56A, 56B, 56C, and aft bridle cable couplings, such couplings shown at 54A, 54B, 54C.

In the present example, a geodetic position signal receiver 48 (such as a GPS receiver or as explained above any other type of geodetic position signal receiver) may be mounted on a suitable portion of the float 40 so that the geodetic position signal receiver 48 is capable of detecting signals from the satellite (6 in FIG. 2). Electrical power to operate various electronic components (not shown in FIG. 2) in the geodetic position signal receiver 48 may be supplied by a turbine-powered electric alternator generator, shown generally at 50 and which may be affixed to the lower deflector frame 52C. The generator 50 converts flow of the water past the paravane 4 into rotational energy to drive an electric alternator or generator (not shown separately) disposed therein. Collectively the foregoing may be referred to as a “generator”, and may include batteries and power conditioning circuitry (not shown separately) to maintain power during slow motion or stopping of the survey system, and to convert the output of the generator to a suitable form for use by the receiver 48 and associated circuitry. The exact structure and location on the paravane 4 chosen for the generator 50 are matters of discretion for the designer and are not intended to limit the scope of the invention. A possible advantage of providing a water-powered generator 50 on the paravanes 4 as shown in FIG. 2A is that the electronic components (geodetic position signal receiver 48 and an acoustic transmitter 9 or receiver 11 as explained below) on the paravane 4 may be operated without the need for special power cables connected, for example, to a nearby streamer.

The example paravane 4 shown in FIG. 2A may also include either an acoustic transmitter 9 or an acoustic receiver 11 as explained above with reference to FIG. 2. Thus, the geodetic position of the transmitter 9 or receiver 11 is essentially the same as or may be directly determined from the geodetic position of the paravane 4 as measured by the geodetic position signal receiver 48.

In the present example, each paravane 4 may include the above components. Because the geodetic position of each paravane 4 is determinable from the signals detected by the geodetic position signal receiver 48, it is then possible by using the acoustic transmitter 9 or receiver 11 to determine relative distances, to estimate the geodetic position of all the other components in the streamers (3 in FIG. 2).

There are several possible advantages to using both the paravanes 4 as platforms for obtaining geodetic position information and determining streamer positions therefrom. First, the position of the submerged acoustic transmitter 9 or receiver 11 with respect to the position of the geodetic position signal receiver 48 is fixed. Thus, no position error is introduced as a result of relative movement between the acoustic transmitter or receiver and the geodetic position signal, receiver. Second, despite relative lateral movement of the paravanes and streamers with respect to the center line of the vessel, the relative position of the forward end of each streamer with respect to the position of the paravanes is relatively stable because the spreader cable interconnecting the paravanes is held in substantial tension by the motion of the paravanes through the water. Finally, the paravane structure results in relatively little pitch or roll motion as the paravane moves through the water. As a result, relative position variation between the paravanes and the forward ends of the streamers is minimized. Because there is a relatively large separation between the two paravanes, the geodetic positions of any device referenced to the paravane geodetic positions can be more accurately determined than, for example, using a single geodetic position reference such as the vessel or the seismic air gun array. Using two, spatially separated geodetic position references also can eliminate the need to measure geomagnetic heading along the streamers (e.g., using compass birds) in order to resolve geodetic positions from a single geodetic position reference and relative position data.

The remainder of the description that follows relates to certain example implementations of devices and methods for determining relative positions between acoustic transmitters and acoustic receivers positioned along the streamers. Such devices and methods may have advantages over other devices and methods known in the art for determining relative positions. As explained above, the relative position data determined, for example as explained below, may be combined with the geodetic position information determined at each of the paravanes to determine geodetic positions along each of the streamers.

FIG. 3 illustrates a perspective schematic view of a portion of a streamer section with geophysical sensors such as seismic receivers, according to an example of the invention. The portion of the streamer section 15 shown contains seismic receivers 12, which will typically be pressure sensitive sensors, such as hydrophones. The seismic receivers 12, as explained above, are distributed at known positions along the streamer sections 15. A series of seismic receivers 12 may be connected together to give a group output signal or the signals from each of the seismic acquisition receivers 12 may be recorded individually. The seismic receivers 12 may be connected via an electrical bundle 14 to receiver processors 13, which, along with the seismic acquisition receivers 12, are connected via the electrical bundle 14 to the main processor 16 (shown in FIG. 2). The receiver processors 13 may be electronics modules that perform many tasks well known in the art, such as the conversion of analog electrical signals generated by the receivers to digital format. Although the receiver processors 13 are illustrated in FIG. 3 as built into the streamer section 15, this location is not intended to be a limitation of the invention. For example, the receiver processors 13 could be located in separate modules (not shown) inserted between the streamer sections 15.

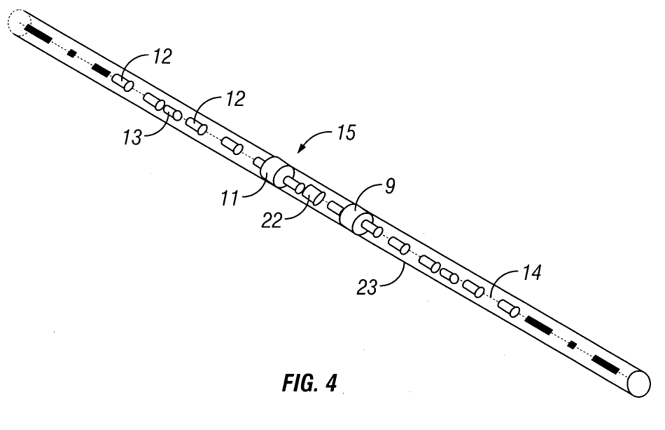

FIG. 4 is a perspective schematic view of a streamer section with streamer position-determining transmitters and receivers, according to an example of the invention. The transmitter 9, introduced in FIG. 2, and a transmitter processor 22 are mounted inside the skin 23 of the streamer section 15 and use wires in the electrical bundle 14 in the streamer section 15 for receiving power and for communication with the main processor 16 (FIG. 2). The transmitter processor 22 is an electronics module which typically comprises a signal generator and a driver stage (neither shown separately). The transmitter processor 22, and hence the transmitter 9, is re-programmable by the main processor 16, via the electrical bundle 14. The transmitter processor 22 receives a time synchronization signal and a triggering schedule from the main processor 16. The transmitter processor 22 utilizes the triggering schedule to tell the transmitter 9 when to transmit signals to the receivers 11, relative to the time synchronization signal from the main processor 16.

In one example, the receivers 11 are dedicated to determining the position of the streamer 3, and are separate from the geophysical signal receivers 12, e.g, seismic receivers for detecting seismic survey signals. In this example, the receivers 11 will then be referred to as position-determining receivers 11, to distinguish them from the seismic acquisition receivers 12.

The position-determining receiver 11 and the receiver processor 13, introduced in FIG. 3, are mounted inside the skin 23 of the streamer section 15 and utilize wires in the electrical bundle 14 in the streamer section 15 for receiving power and for communication with the main processor 16. The receiver processor 13, and hence the position-determining receiver 11, is re-programmable by the main processor 16, via the electrical bundle 14. The receiver processor 13 receives a time synchronization signal and a set of time windows from the main processor 16. The receiver processor 13 utilizes the time window to tell the position-determining receiver 11 when to receive signals from the transmitters 9, relative to the time synchronization signal from the main processor 16.

The transmitter processor 22 communicates via the electrical bundle 14 with the main processor 16 (FIG. 2) and receives the time synchronization signals and the pre-set triggering schedule from the main processor 16. The transmitter processor 22 utilizes the triggering schedule to determine when a transmitter 9 should transmit signals, relative to the reception time of the time synchronization signals received from the main processor 16. At the determined time, the signal generator in the transmitter processor 22 generates the transmit signal, which is then amplified in the driver stage in the transmitter processor 22. Finally, the transmitter processor 22 sends the amplified transmit signal via the electrical bundle 14 to the transmitter 9 for transmission to the position-determining receivers 11.

When one of the position-determining receivers 11 receives the transmitted acoustic signal from one of the transmitters 9, the received signal is sent via the electrical bundle 14 to the receiver processor 13 associated with the receiver 11. The receiver processor 13 typically applies preliminary signal conditioning to the received signal before further processing. This signal conditioning may include, but is not limited to, pre-amplifying, filtering, and digitizing. The digitizing is only applied to that portion of the received signal that arrives at the position-determining receiver 11 during one of its pre-set time windows, thus limiting the received signals to the time windows. Thus, the transmitted signals are only transmitted according to triggering schedules for each transmitter 9 and only received during time windows for each position-determining receiver 11, all coordinated and time synchronized by the main processor 16.

A time window for listening for signals at a particular position-determining receiver 11 corresponds to a travel distance range for a signal transmitted between a transmitter 9 and that particular position-determining receiver 11. Thus, this coordination of triggering schedules and time windows by the main processor 16 controls which position-determining receivers 11 receive signals from which transmitters 9. In particular, this coordination limits the possible transmitters 9 that each of the position-determining receivers 11 can receive signals from. Indeed, each of the position-determining receivers 11 can be limited to receiving signals from only one possible transmitter 9. Further, the possible transmitter or transmitters 9 that a particular position-determining receiver 11 can receive signals from, can change in time under the control of the main processor 16.

The digitized received signal is further processed by the receiver processor 13 associated with the position-determining receiver 11. The receiver processor 13 confirms reception of the received signal at the position-determining receiver 11 from a particular transmitter 9. This confirmation of transmission of the received signal from the transmitter 9 is accomplished in the present invention by cross-correlation of the received signal from the position-determining receiver 11 with copies (replicas) of the transmitted signal from the possible transmitters 9. In addition, the receiver processor 13 determines the arrival time of the received signal at the position-determining receiver 11. This arrival time determination is also accomplished in the present invention by the same cross-correlation of received signal with a transmitted signal copy. Further, before continuing, another possible source of signal degradation is compensated for. Since the relative distance between a transmitter 9 and a position-determining receiver 11 varies, the received signal may be shifted, either compressed or expanded, relative to the transmitted signal, due to Doppler effects. Thus, the receiver processor 13 has to determine the appropriate Doppler shift that compensates for these Doppler effects before further processing of the received signal can be undertaken. This determination of Doppler shift is again accomplished in the present invention by the same cross-correlation of received signal with transmitted signal copy, as before. Thus, these cross-correlations need only be calculated once for each possible combination of received signal, transmitted signal copy, and Doppler shift, to determine the appropriate Doppler compensation for the received signal, the identity of the transmitter 9 of the received signal, and the arrival time of the received signal. This computational parsimony yields increased efficiency for the method of the present invention.

Once the receiver processor 13 confirms the transmission of the received signal from a particular transmitter 9 to the position-determining receiver 11, the receiver processor 13 employs the triggering schedule of that transmitter 9 to acquire the transmission time for the received signal. Then, the receiver processor 13 can calculate the difference between the transmission and arrival times of the received signal. This time difference yields the travel time between this particular pair of transmitter 9 and position-determining receiver 11 at this particular time. With knowledge of this travel time and the current speed of sound in the water, the distance between the transmitter 9 and the position-determining receiver 11 may be calculated. Typically, this calculation is performed in the main processor 16, although this assignment is not intended to be a limitation on the invention. Thus, the travel time is sent via the electrical bundle 14 from the receiver processor 13 to the main processor 16.

In a preferred embodiment, the receiver processor 13 performs the cross-correlations of the received signal with copies of possible transmitter 9 signals in an iterative scheme. For a particular received signal at a particular position-determining receiver 11, the receiver processor 13 determines a set of possible transmitters 9 that could be the source of that received signal. This determination may be accomplished, for example, by comparing the triggering schedules of the transmitters 9 with the time window of the position-determining receiver 11 during which the received signal arrived. This comparison may be done by either the receiver processor 13 after receiving the necessary information (triggering schedules and time windows) from the main processor 16 or by the main processor 16 before sending the result (possible transmitters 9) to the receiver processor 13.

The iterative scheme begins by iteratively checking each of the set of possible transmitters 9 determined above. The receiver processor 13 selects one transmitter 9 from the set of possible transmitters 9. The receiver processor 13 supplies a copy of the unique transmitted signal for the transmitter 9 that the receiver processor 13 is looking at. In one embodiment, copies of the different transmitter signals are stored in the receiver processor 13. In another embodiment, the copies of the transmitter signals are generated by the receiver processor 13. The invention is not limited to these two particular embodiments, as other methods known in the art could be employed.

Next, the receiver processor 13 determines a set of possible Doppler shifts to compensate the received signal for the Doppler effects that might be anticipated due to survey conditions, such as the size and direction of currents in the vicinity of the transmitter 9 and position-determining receiver 11 being investigated. Doppler compensation is accomplished by removing data samples from or adding data samples to the received signal, according to whether the received signal is being compressed or expanded, respectively, by Doppler effects. The iterative scheme of the invention will then iteratively check each of this set of possible Doppler shifts. The receiver processor 13 selects one Doppler shift from this set of possible Doppler shifts and applies this Doppler shift to the received signal.

The receiver processor 13 calculates the cross-correlation of the Doppler-compensated received signal with the copy of the transmitted signal for the transmitter 9 being checked. The receiver processor 13 calculates the envelope of the cross-correlation and then determines the first peak in the correlation envelope to have a sufficient correlation signal to correlation noise ratio to be significantly detectable above the correlation noise. The receiver processor 13 may apply a peak detection algorithm to determine the first peak or apply any other method well known in the art. The receiver processor 13 calculates the correlation signal to correlation noise ratio of and time for this detected correlation peak and saves both peak correlation signal to correlation noise ratio and peak time in memory for later retrieval. The term correlation signal to correlation noise ratio will be used here to mean the ratio of the signal in the correlation envelope to the noise in the correlation envelope, as measured at the first detectable peak in the correlation envelope.

The iterative scheme of the invention checks each of the remaining Doppler shifts in the set of possible Doppler shifts. The receiver processor 13 repeats the cross-correlations described above for all of the possible Doppler shifts. The Doppler shift that yields the best of the saved correlation peak signal-to-noise ratios for the received signal is designated as the Doppler shift compensation for that particular transmitter 9 and position-determining receiver 11 combination. The saved peak time of the detected correlation peak for the designated Doppler compensation will be designated as the estimated arrival time for the received signal from that transmitter 9.

The iterative scheme of the invention checks each of the remaining transmitters 9 in the set of possible transmitters 9. The receiver processor 13 repeats the above steps for finding the Doppler compensation and estimated arrival time, described in the previous paragraph, for all possible transmitters 9. The transmitted signals from different transmitters 9 are designed in the invention with low cross-correlations. Thus, the calculated cross-correlations of the received signal with the copies of the transmitted signals from different transmitters 9 should be low for all transmitters 9 except the actual transmitter 9 of the received signal. The first location of a correlation peak with sufficient correlation signal to correlation noise ratio to be significantly detectable within the time window of the position-determining receiver 11 is used to determine the arrival time of the received signal from the source transmitter 9.

The receiver processors 13 repeat the above-described iterative scheme of the invention for all received signals and their corresponding position-determining receivers 11 to identify the source transmitters 9 of, and estimate the arrival times for, all received signals at all position-determining receivers 11.

Then, the receiver processors 13 can determine travel times between the pairs of transmitters 9 and position-determining receivers 11 determined by the previously-described iterative cross-correlation scheme. The receiver processor 13 calculates the time difference between the start time and the arrival time of the corresponding received signal. The receiver processor 13 knows the start time of the received signal from the triggering schedule for the source transmitter 9, as confirmed by the cross-correlation results. The receiver processor 13 knows the arrival time of the received signal from the detected first correlation peak of the received signal, as determined from the cross-correlation results. The receiver processors 13 repeat this calculation for all received signals to yield the travel times between pairs of transmitters 9 and position-determining receivers 11.

The receiver processors 13 send the travel times to the main processor 16. Alternatively, the travel times may be measured and sent as numbers of clock periods instead of actual time. Temperature-compensated quartz crystal oscillators could be used as clocks in the receiver processors 13 to give sufficient accuracy and stability along with minimal size and power consumption. The main processor 16 utilizes these travel times, multiplied by the local sound velocity in the water, to calculate the travel distances between the transmitters 9 and the position-determining receivers 11. The local sound velocity in water may be estimated, measured by sound velocity sensors located along the seismic streamers, or obtained by any other means known in the art.

The main processor 16 combines the travel distances between the pairs of transmitters 9 and position-determining receivers 11 into a trilateration network representation of the transmitters 9 and position-determining receivers 11 in the towed marine seismic streamers 3. A trilateration network is a two-dimensional model using triangular-shaped elements to represent the known relative distances between the unknown transmitter 9 and position-determining receiver 11 positions (nodes). Standard mathematical techniques are known in the art for solving for the nodes in a trilateration network. Thus, the main processor 16 can determine the relative positions of the towed marine seismic streamers 3 from the calculated positions of the transmitters 9 and position-determining receivers 11 on the streamers 3.

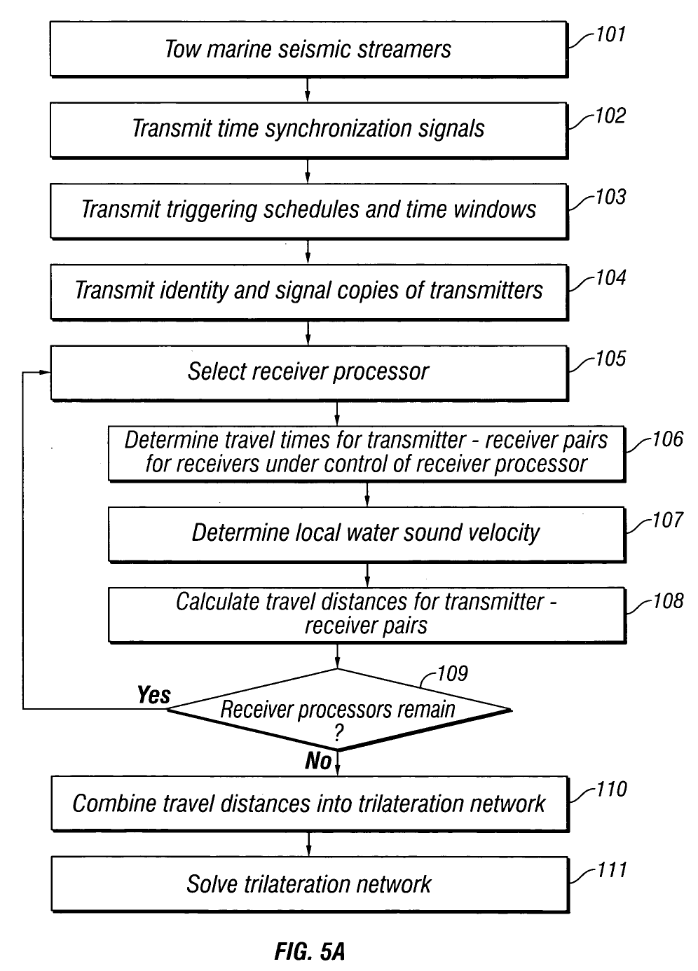

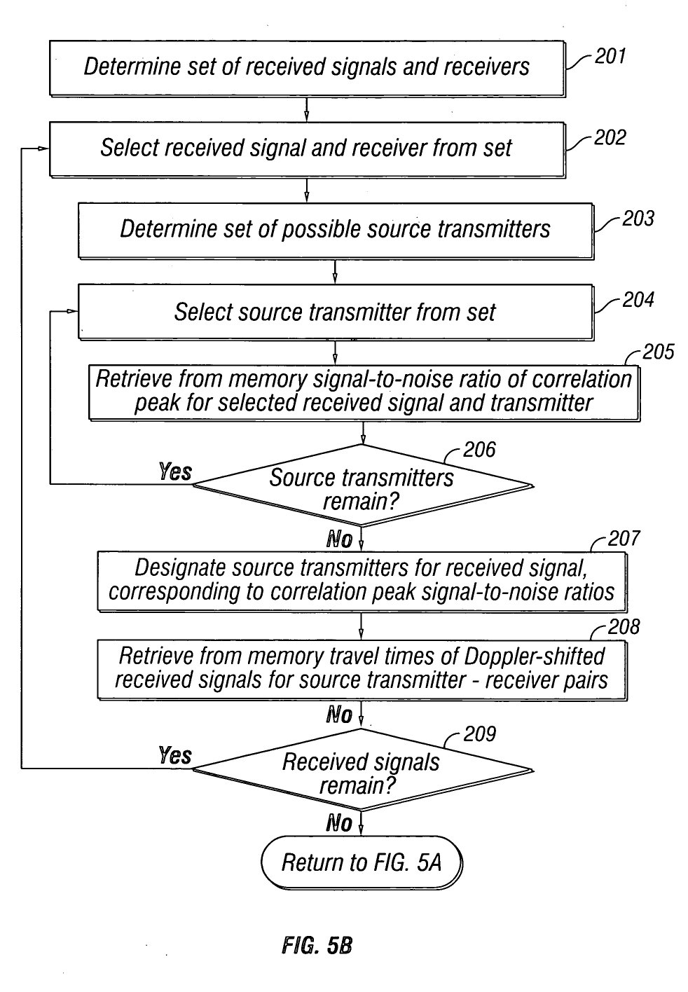

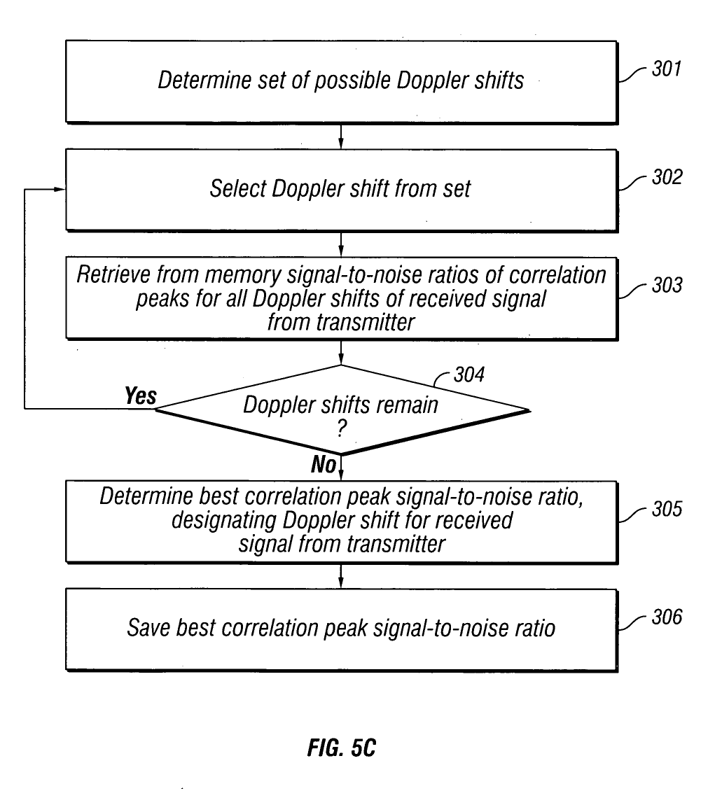

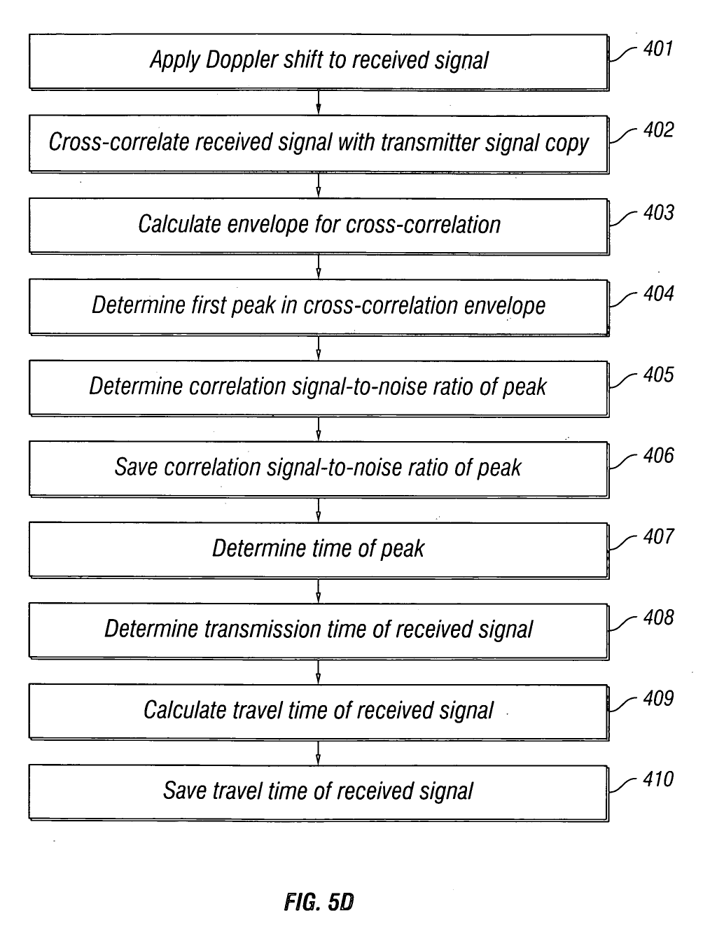

FIGS. 5A, 5B, 5C, and 5D show a series of flowcharts illustrating the steps of an example of the method of the invention for determining the relative positions of towed marine seismic streamers. The invention is illustrated by an example in which the processing units comprise a network with a main. processor located onboard the seismic survey vessel and a plurality of distributed receiver processors located within the seismic streamers. However, the processor units can be distributed throughout any type of network at any appropriate location or combination of locations, including, but not limited to, the seismic survey vessel, other vessels, the towed streamers, and any other part of the tow system. The number, types, location, or relationship of the members of the processing network is not a limitation of the invention.

FIG. 5A is a flowchart illustrating the processing steps of a main processor for an example of the method of the invention for determining the relative positions of towed marine seismic streamers.

At step 101, a plurality of marine seismic streamers are towed, typically by a seismic survey vessel. A plurality of transmitters and a plurality of receivers are mounted within streamer sections in the towed marine seismic streamers. A main processor is located on board the survey vessel. Transmitter processors and receiver processors are mounted within the streamer sections in the towed marine seismic streamers. The plurality of transmitters comprise acoustic transducers dedicated to the task of determining the positions of the streamers. The plurality of receivers comprise two sets of receivers. The first set of receivers comprise conventional seismic receivers dedicated to the task of acquiring seismic data. These seismic acquisition receivers are typically pressure sensors, such as hydrophones, but could also include particle motion sensors, such as geophones or accelerometers, or any other seismic detectors known in the art. The second set of receivers comprise acoustic transducers dedicated to the task of determining the positions of the streamers.

At step 102, the main processor transmits time synchronization signals to all of the transmitter processors and receiver processors of step 101.

At step 103, the main processor transmits triggering schedules for each transmitter to the transmitter processors of step 101 controlling those transmitters and to those receiver processors of step 101 that control position-determining receivers that might receive signals from these transmitters. The main processor also transmits sets of time windows for each position-determining receiver to the receiver processors of step 101 controlling those receivers.

At step 104, the main processor sends the identity of and a copy of the transmitted signal used by that transmitter to the receiver processors of step 101.

At step 105, the main processor selects a receiver processor from the plurality of receiver processors of step 101. Alternatively, the receiver processors may initiate the following steps under their own control, rather than under the control of the main processor. The source of control of the receiver processors is not a limitation of the invention. This step is a formal procedure for considering all the receiver processors and their processing results in a systematic fashion, for illustrative purposes only.

At step 106, the main processor determines travel times for received signals transmitted from (source) transmitters to the position-determining receivers under the control of the receiver processor selected in step 105. In the example being illustrated, the main processor receives these travel times for received signals between transmitter-receiver pairs from the selected receiver processor, where the travel times are calculated.

In the example being illustrated, this calculation of the travel times is illustrated in the processing that is performed in the flowchart in FIG. 5B. That is, the process goes to the beginning, step 201, of FIG. 5B with the identity of the selected receiver processor and then returns here to step 106 from the end, step 209, of FIG. 5B with the calculated travel times for received signals between transmitter-receiver pairs for all receivers under the control of the selected receiver processor. In particular, the process returns with the identity of the source transmitters designated in step 207, the corresponding travel times retrieved in step 208, and the corresponding position-determining receiver determined in step 201, for each received signal selected in step 202 of FIG. 5B.

At step 107, the main processor determines the local sound velocity in the water in the vicinity of the pairs of source transmitters and position-determining receivers corresponding to the received signals, as determined in step 106.

At step 108, the main processor calculates the travel distances between the pairs of source transmitters and position-determining receivers corresponding to the received signals, as determined in step 106. The main processor calculates the travel distances by multiplying the travel times of the received signals, as determined in step 106, by the local sound velocity in water determined in step 107.

At step 109, the main processor determines if there are any remaining receiver processors left to check from the plurality of receiver processors in step 101. If the answer is yes, there are receiver processors left to check, then the process returns to step 105. If the answer is no, there are no receiver processors left to check, then the process continues to step 110.

At step 110, the main processor combines the travel distances calculated in step 108 between pairs of transmitters and position-determining receivers to construct a trilateration network representation of the distances between all the pairs of transmitters and position-determining receivers in the towed marine seismic streamers.

At step 111, the main processor solves the trilateration network constructed in step 110 to obtain the relative positions of the transmitters and the position-determining receivers in the towed marine seismic streamers. Standard mathematical techniques are known in the art for solving a trilateration network. The positions of the transmitters and the position-determining receivers, if sufficiently distributed along the streamers, yields the shape and relative positions of the towed marine seismic streamers.

Thus, in the flowchart in FIG. 5A, the main processor determines the travel times of all received signals transmitted from the transmitters to the position-determining receivers and utilizes these travel times to determine the relative positions of the towed marine seismic streamers. The next flowchart in FIG. 5B shows a portion of the iteration scheme that each receiver processor employs to determine the travel times for the received signals at the position-determining receivers under its control.

FIG. 5B is a flowchart illustrating the processing steps of a selected receiver processor for an example of the method of the invention for determining travel times of received signals transmitted by transmitters to the position-determining receivers under the control of the selected receiver processor.

At step 201, the receiver processor selected by the main processor in step 105 of FIG. 5A determines a set of received signals for each of the position-determining receivers under the control of the selected receiver processor. The received signals are those signals transmitted by the position-determining transmitters and received by the position determining receivers. Typically, the position-determining receiver controlled by the receiver processor will be located in the same streamer section as the receiver processor, but this location is not intended to be a limitation of the invention.

At step 202, the receiver processor selects a received signal and the corresponding position-determining receiver that received the received signal from the set of received signals and corresponding position-determining receivers determined in step 201.

At step 203, the receiver processor determines a set of possible source transmitters for the received signal received at the corresponding position-determining receiver selected in step 202. The receiver processor determines the set of possible source transmitters for the received signal by comparison of the triggering schedules for the transmitters and the currently-investigated time window for the corresponding position-determining receiver, transmitted from the main processor in step 103 of FIG. 5A.

At step 204, the receiver processor selects a transmitter from the set of possible source transmitters for the received signal, as determined in step 203.

At step 205, the receiver processor retrieves from memory the correlation signal to correlation noise ratio of the correlation peak for the received signal selected in step 202 for the transmitter selected in step 204. In the example being illustrated, this correlation signal to correlation noise ratio is obtained from the processing that is performed in the flowchart in FIG. 5C. That is, the process goes to the beginning, step 301, of FIG. 5C with the identity of the selected received signal and selected possible source transmitter, and then returns here from the end, step 306, of FIG. 5C with the retrieved correlation signal to correlation noise ratios. In particular, the correlation signal to correlation noise ratio of the correlation peak corresponding to the Doppler shift for the selected received signal from the selected transmitter is saved in memory in step 306 of FIG. 5C.

At step 206, the receiver processor determines if there are any remaining transmitters left to check from the set of possible transmitter sources determined in step 203. If the answer is yes, there are transmitters left to check, then the process returns to step 204. If the answer is no, there are no transmitters left to check, then the process continues to step 207.

At step 207, the receiver processor determines which selected transmitter corresponds to each of the correlation signal to correlation noise ratios of the correlation peaks retrieved in step 205 and designates each of these selected transmitters as source transmitters for the received signal selected in step 202.

At step 208, the receiver processor retrieves from memory the corresponding travel times of the Doppler-shifted received signals between the source transmitters designated in step 207 and the corresponding position-determining receiver selected in step 202. These travel times are all designated as possible travel times of the received signal selected in step 202. In the example being illustrated, these travel times are obtained from the processing that is performed in the flowchart in FIG. 5D. In particular, the corresponding travel times of the Doppler-shifted received signals for the source transmitters are saved in memory in step 410 of FIG. 5D.

At step 209, the receiver processor determines if there are any remaining received signals and corresponding position-determining receivers left to check from the set of received signals and corresponding position-determining receivers in step 201. If the answer is yes, there are received signals and corresponding position-determining receivers left to check, then the process returns to step 202. If the answer is no, there are no received signals and corresponding position-determining receivers left to check, then the process returns to step 106 of FIG. 5A. The process returns with the identity of the source transmitters designated in step 207, the corresponding travel times retrieved in step 208, and the corresponding position-determining receiver determined in step 201, for each received signal selected in step 202.

Thus, in the flowchart in FIG. 5B, the receiver processor determines the identities of all possible source transmitters and the corresponding travel times for all received signals received by all position-determining receivers under the control of one selected receiver processor. The next flowchart in FIG. 5C shows a remaining portion of the iteration scheme that each receiver processor employs to determine the travel times for the received signals at its position-determining receivers.

FIG. 5C is a flowchart illustrating the processing steps of a receiver processor for an example of the method of the invention for determining a properly-compensating Doppler shift, source transmitter identity, and travel time for a received signal at a position-determining receiver under the control of the receiver processor.

At step 301, the receiver processor determines a set of possible Doppler shifts to compensate for Doppler effects on the received signal selected in step 202 of FIG. 5B.

At step 302, the receiver processor selects one of the Doppler shifts from the set of possible Doppler shifts determined in step 301.

At step 303, the receiver processor retrieves from memory the correlation signal to correlation noise ratios of the correlation peaks for all the Doppler shifts selected in step 302 for one received signal selected in step 202 of FIG. 5B for one transmitter selected in step 204 of FIG. 5B. In the example being illustrated, these correlation signal to correlation noise ratios are obtained from the processing that is performed in the flowchart in FIG. 5D. In particular, the correlation signal to correlation noise ratios of the correlation peaks for all the Doppler shifts are saved in memory in step 406 of FIG. 5D.

At step 304, the receiver processor determines if there are any remaining Doppler shifts left to check from the set of possible Doppler shifts determined in step 301. If the answer is yes, there are Doppler shifts left to check, then the process returns to step 302. If the answer is no, there are no Doppler shifts left to check, then the process continues to step 305.

At step 305, the receiver processor determines which of the correlation signal to correlation noise ratios of the correlation peaks from step 303 is the best. The Doppler shift yielding this best correlation peak signal-to-noise ratio is designated as the properly-compensating Doppler shift for the received signal from the selected transmitter.

At step 306, the receiver processor saves the correlation signal to correlation noise ratio of the correlation peak determined in step 305 as corresponding to the properly Doppler-shifted received signal from the selected transmitter. The selected transmitter corresponding to this saved correlation signal to correlation noise ratio is determined in step 207 of FIG. 5B and designated as a possible source transmitter for the received signal selected in step 202 of FIG. 5B. This transmitter is combined with any other transmitters designated as possible source transmitters for the selected received signal in step 207 of FIG. 5B, after the transmitters are determined to correspond to the correlation signal to correlation noise ratios in step 305.

Thus, in the flowchart in FIG. 5C, the selected receiver processor determines the properly-compensating Doppler shift for one selected received signal from one selected transmitter to one selected position-determining receiver. The final flowchart in FIG. 5D demonstrates how the receiver processor calculates this information within the same iteration step.

FIG. 5D is a flowchart illustrating the processing steps of a receiver processor for an example of the method of the invention for calculating a selected Doppler shift and a resulting travel time for a selected received signal from a selected transmitter to a position-determining receiver under the control of the receiver processor.

At step 401, the receiver processor applies the Doppler shift selected in step 302 of FIG. 5C to the received signal selected in step 202 of FIG. 5B. The receiver processor applies the selected Doppler shift by removing data samples from or adding data samples to the received signal, according to whether the received signal is being compressed or expanded, respectively, by Doppler effects.

At step 402, the receiver processor calculates a cross-correlation of the Doppler-shifted received signal from step 401 with the copy of the transmitted signal received in step 104 of FIG. 5A for the transmitter selected in step 204 of FIG. 5B.

At step 403, the receiver processor calculates an envelope for the cross-correlation calculated in step 402.

At step 404, the receiver processor determines a peak in the correlation envelope calculated in step 403. Preferably, the receiver processor applies a peak detection algorithm to determine the first peak with sufficient signal-to-noise ratio to be significantly detectable within the time window of the position-determining receiver, received from the main processor in step 103 of FIG. 5A.

At step 405, the receiver processor determinates the correlation signal to correlation noise ratio of the peak determined in step 404. The term correlation signal to correlation noise ratio is used here to mean the ratio of the signal in the correlation envelope to the noise in the correlation envelope, as measured at the first detectable peak in the correlation envelope.

At step 406, the receiver processor saves the correlation signal to correlation noise ratio of the peak determined in step 405, as corresponding to the selected Doppler shift for the received signal from the selected transmitter. This saved correlation signal to correlation noise ratio is compared in step 305 of FIG. 5C to other saved correlation signal to correlation noise ratios determined in step 405 to determine the properly-compensating Doppler shift for the received signal from the selected transmitter.

At step 407, the receiver processor determines a time for the correlation peak determined in step 404. The time of the peak is designated as the arrival time of the Doppler-shifted received signal calculated in step 401 from the selected transmitter.

At step 408, the receiver processor determines the time of transmission of the Doppler-shifted received signal calculated in step 401. The receiver processor determines the time of transmission of the Doppler-shifted received signal from the triggering schedule for the selected transmitter, received from the main processor in step 103 of FIG. 5A.

At step 409, the receiver processor calculates the travel time of the Doppler-shifted received signal between the selected transmitter and the position-determining receiver. The receiver processor calculates the travel time by calculating the difference between the arrival time determined in step 407 of the Doppler-shifted received signal and the transmission time determined in step 408 of the Doppler-shifted received signal.

At step 410, the receiver processor saves the travel time calculated in step 409 of the Doppler-shifted received signal between the selected transmitter and the position-determining receiver.

Thus, in the above flowchart in FIG. 5D, the receiver processor calculates and saves in memory one correlation signal to correlation noise ratio and one resulting travel time for one selected Doppler-shifted received signal from one selected transmitter to one selected position-determining receiver.

The preceding flowcharts in FIGS. 5A to 5D merely illustrate a detailed description of one specific example of the method of this invention and this illustration is not meant to limit the scope of the invention.

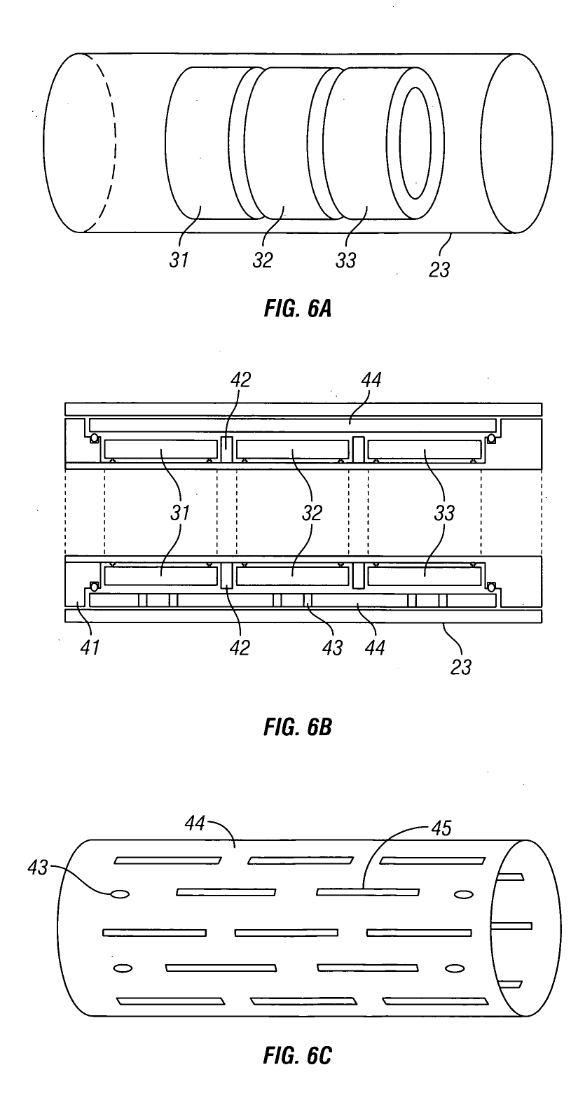

FIGS. 6A, 6B, and 6C illustrate different views of a transmitter suitable for use within the system of the invention. In one embodiment, the transmitter comprises one or more transmitter ring elements of piezoelectric material. If more than one ring is used, then the material properties may differ so that the overall frequency range of the transmitter becomes broader than for a single transmitter ring. The particular with three transmitter ring elements will be illustrated here.

FIG. 6A is a side schematic view of a broad band transmitter, as mounted in a streamer, according to one example of the invention. FIG. 6A illustrates a symmetrical transmitter design based on three piezoelectric tube elements of approximately equal diameters, positioned collinearly within the streamer skin 23. Both the diameters of and the speed of sound in outer tubes 31, 33 are substantially equal, giving close resonance frequencies. The diameter of center tube 32 is approximately the same as for the two outer tubes 31, 33. However, the speed of sound in the center tube 32 differs from the speed of sound in the two outer tubes 31, 33 by 10% or more, resulting in more than 10% difference in resonance frequencies between the center tube 32 and the outer tubes 31, 33. Outer tubes 31, 33 are operated together, and used for transmission in a first frequency band around their resonance frequency. Center tube 32 is used for transmission in a second frequency band different from the first frequency band of outer tubes 31, 33. This design results in a combined bandwidth wider than the bandwidth of a single tube and with a beam pattern that has the same origin for both frequency bands. This example of the invention increases the bandwidth of the transmitted signal.

In one embodiment, the tubes 31, 32, 33 can be used for signal transmission on one frequency band at a time, or, in another embodiment, used on both frequency bands simultaneously. In particular, the tube 32 with the highest resonance frequency can be located in the center, and the tubes 31, 33 with lower resonance frequencies can be placed symmetrically to each side of the tube 32, in order to increase the bandwidth of the transmitter. In yet further embodiments, further pairs of tubes (not shown), each pair with a resonance frequency different from previous tubes, may be added symmetrically, one on each side of the design described above, to increase the combined bandwidth further.

FIG. 6B is a side sectional view of the broad band transmitter shown in FIG. 6A. A protective tube 44 perforated with holes 43 is used to protect the brittle piezoelectric transmitter tubes 31, 32, 33 when the streamer is affected by large external forces due to handling on deck or in water. These external forces arise, for example, when the streamer cable is rolled over pulleys or wheels as the streamer cable is deployed from or retrieved onto the survey vessel, or stored on streamer winches on board the survey vessel. Under normal operational conditions, the protective tube 44 is in fluid and is substantially decoupled, both acoustically and mechanically, from the internal structure of the broad band transmitter. When large radial forces are applied to the streamer skin 23, support elements 41 and 42 will stop the protection tube 44 from reaching the piezoelectric transmitter tubes 31, 32, 33.

FIG. 6C is a side view of the protective tube 44 shown in the transmitter of FIG. 6B. FIG. 6C illustrates that the protective tube 44 can be perforated with holes 43 that allow for fluid flow through the holes 43, in order to equalize ambient pressure on the inside and outside of the tube 44. The protection tube 44 can further be perforated with slots 45 parallel to the streamer axis, so that the radial mode resonance of the protective tube 44 is moved out of the frequency band of the transmitters.

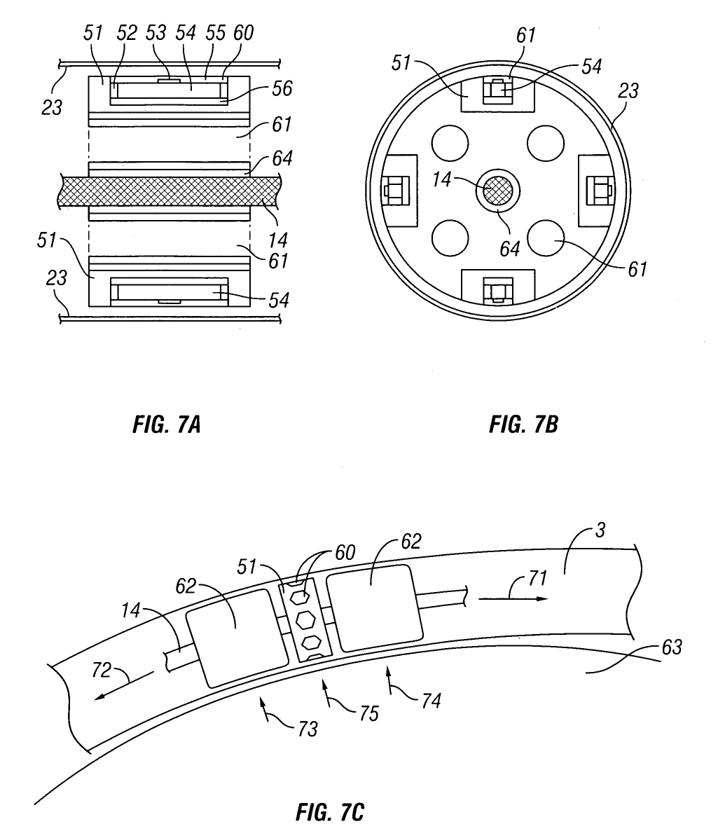

FIGS. 7A, 7B, and 7C illustrate different views of a receiver suitable for use within the system of the invention. In one embodiment, the receiver may consist of one or more piezoelectric ring elements, similar to the design of the transmitter illustrated in FIGS. 6A, 6B, and 6C, above. Here, however, an alternative example will be illustrated for the design of the receiver, in which a series of transducer disk elements are placed around the circumference of a circular mechanical structure. If several transducer elements are used, the signals from these may be added together. The use of several small transducer elements puts the resonances of piezoceramic elements well outside the frequency band of interest for the receivers, which is typically 10 kHz to 40 kHz.

FIG. 7A is a side sectional view of a broad band acoustic receiver, according to an example of the invention. FIG. 7A illustrates an omni-directional acoustic receiver design employing one or more small piezoceramic elements 54 mounted in cavities 60 in a hydrophone assembly 51. A high-frequency broad band hydrophone for in-streamer mounting can be implemented by placing piezoceramic elements 54 at a plurality of locations under the circumference of the streamer skin 23 to detect the ambient pressure at these locations. The signals from all elements are added to form one output signal. As the dimension of the piezoceramic elements 54 is small, it is possible to achieve an almost flat sensitivity response in the frequency band of interest, typically 10 kHz to 40 kHz. The electrical bundle 14 and other streamer structural elements such as tension ropes may be inserted through a central hole 64 and through additional holes 61 in the hydrophone assembly 51.

FIG. 7B is a cross-sectional view of the acoustic receiver of FIG. 7A. FIG. 7B illustrates an example in which each piezoceramic element 54 is mounted in a cavity 60 in the hydrophone assembly 51. Thus, local stress and bending forces are minimized when the streamer 3 is affected by large lateral forces, such as during handling in water or onboard the vessel, as described above in reference to FIG. 6B. A piezoceramic element 54 can withstand high positive pressure, but can not handle negative pressure well, and thus breaks easily when bending forces are applied. The hydrophone assembly 51 has holes 61, which are illustrated as circles here, but this shape is not intended as a limitation of the invention. The holes 61 allow in-line movements of the hydrophone assembly 51 in the streamer 3. Under normal operational conditions, the hydrophone assembly 51 is substantially decoupled, both acoustically and mechanically, from the internal structure of the streamer 3.

Referring again to FIG. 7A, concentrated stress on an element 54 is avoided by using compliant conducting tapes 53, 56 instead of conventional soldered wire connections to the electrodes of the piezoceramic elements 54. The conducting tape 53, 56 can be made of any appropriate compliant material, such as copper, that deforms slightly under pressure and thus equalizes the pressure over the piezoceramic surface. A layer of plastic material 55 covers the outside of the piezoceramic element 54. This material 55 and the streamer skin 23 deform slightly under external pressure and distribute the externally applied forces (73, 74, 75 in FIG. 7C) over the surface of the piezoceramic element 54. A soft compliant material 52 is used to allow the element 54 to expand laterally when pressure (71, 72 in FIG. 7C) is applied to the element front surface. This is a common procedure used to increase sensitivity, compared with the case commonly referred to as clamped thickness mode, where the element 54 is not allowed to expand laterally.

FIG. 7C is a side schematic view of the acoustic receiver of FIGS. 7A and 7B, as mounted in a streamer. FIG. 7C illustrates an example in which the hydrophone assembly 51 is placed between two spacers 62, generally centered on the electrical bundle 14. The hydrophone assembly 51 has a smaller diameter than the spacers 62, which will then carry most of the external forces 73, 74, 75 when the streamer 3 is rolling over wheels 63 during streamer 3 deployment or retrieval, protecting the piezoceramic elements within the cavities 60 in the hydrophone assembly 51.

The system of the invention is a method and system for determining streamer positions. Acoustic broadband signals operating at frequencies at the lower part of the ultrasonic band, typically 10 kHz to 40 kHz, are generated and transmitted in sequential order from transmitters within a subset of streamer sections of the parallel towed streamers. The acoustic signals can be detected by a different subset of receivers, processed, and the propagation times between a large number of acoustic transmitter and receiver combinations determined. Accurate timing control is provided to synchronize all transmit and receiving events. The corresponding distances between the transmitter and receiver combinations are computed, and a spatial distribution of the complete seismic streamer spread can be determined. Relative positions of the seismic equipment within the towed streamers are then determined. The geodetic position of each paravane is determined using the geodetic position signal receiver on each paravane. The relative positions may be combined with the determined geodetic position to determine the geodetic positions of the streamers.

Using the paravanes as platforms for fixing geodetic positions of portions of the survey system during operation may provide certain advantages over other techniques for determining geodetic positions of the streamers. Position fixing by measurements of geodetic position proximate the front of the streamers provides geodetic position that is substantially independent of the towing vessel position. Thus, lateral displacements of the towed equipment from the vessel centerline may be excluded from streamer position determination. The lateral distance between the paravanes gives a long baseline which improves the precision available. Methods according to the invention do not involve geomagnetic heading measurements from compass birds or similar magnetic sensors. Methods according to the invention do not require towing of separate signal receiver floats or similar equipment. The geodetic position receiver and the acoustic position determination sensors are mounted on a solid frame, thus minimizing any horizontal offset error such as may occur when using the source array as a platform for such devices. Finally, the paravanes are highly stable floating platforms, and provide minimal roll and pitch of the receiver antenna and submerged acoustic sensor.

It should be clearly understood that while the preceding description is made with reference to towed seismic sensing systems, the invention is equally applicable to a towed marine sensing system array making use of other types of sensors, for example electromagnetic sensors, temperature sensors, or any other sensor used to make spatially distributed measurements at known relative and/or geodetic positions. Accordingly, all reference herein to seismic sensors is meant to illustrate the principle of the invention and not to limit its scope.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A system for determining geodetic positions of a plurality of marine geophysical sensor streamers, comprising:
a plurality of laterally spaced apart sensor streamers each functionally coupled at
a forward end thereof to a towing vessel;
a paravane disposed laterally outwardly on each side of the plurality of streamers, the paravanes configured to maintain lateral selected separation between adjacent streamers;
a plurality of acoustic transmitters disposed at spaced apart locations along the streamers, the transmitters configured to transmit signals enabling identification of each of the transmitters from which the signals originate;
a plurality of acoustic receivers disposed at spaced apart locations along the streamers, the receivers configured to receive the signals from the transmitters;
a geodetic position signal receiver, and at least one of the acoustic transmitters and the acoustic receivers disposed on each paravane;
at least one processor configured determine identities of transmitters of received acoustic signals and travel times of the received acoustic signals, the processor configured to convert the travel times to distances in both an in-line direction along streamers between transmitters and acoustic receivers in the same streamer, and in a cross line direction between transmitters and acoustic receivers in different streamers, the processor configured to determine relative positions of the streamers from the distances, the processor configured to determine geodetic positions of the streamers from the relative positions and the signals detected by the geodetic position signal receiver on each paravane.

2. The system of claim 1, wherein the acoustic receivers are used exclusively for determining the positions of the streamers.

3. The system of claim 1, wherein:
the processor is configured to transmit time synchronization signals to transmitter processors adapted to control the transmitters;
the processor is configured to transmit triggering schedules for transmitting signals to the transmitter processors; and
wherein the processor is configured to use the time synchronization signals and the triggering schedules to control transmitting the signals from the transmitters.

4. The system of claim 1, wherein the processor is configured to compensate the received acoustic signals for Doppler effects.

5. The system of claim 1, wherein the processor is configured to store copies of the transmitter signals.

6. The system of claim 1, wherein the processor is configured to generate copies of the transmitter signals.

7. The system of claim 1, further comprising:
sound velocity sensors deployed along the streamers configured to determine a local sound velocity in water; and
wherein: the processor is configured to use the local sound velocity in water to convert the travel times to distances.

8. The system of claim 1, wherein the acoustic transmitters and the acoustic receivers are configured to operate in a frequency band of approximately 10 to 40 kHz.

9. The system of claim 1 wherein the geodetic position signal receiver comprises a global positioning satellite receiver.

10. The system of claim 1 further comprising an electric generator disposed on each deflector, each generator configured to be operated by movement of the paravane through water, each generator functionally coupled to the geodetic position signal receiver.

11-16. (canceled)
